(19) United States
(12) Patent Application Publication
(10) Pub. No.: US 2014/0118628 A1
(43) Pub. Date: May 1, 2014

(54) Display Device and Television Set

(71) Applicant: Funai Electric Co., Ltd., Osaka (JP)

(72) Inventors: Hirofumi HORIUCHI, Daito-shi (JP); Akifumi KONO, Daito-shi (JP)

(73) Assignee: Funai Electric Co., Ltd., Osaka (JP)

(21) Appl. No.: 14/061,059

(22) Filed: Oct. 23, 2013

(30) Foreign Application Priority Data
Oct. 26, 2012 (JP) 2012-237297

(51) Int. Cl. H04N 5/66; F21V 8/00

(52) U.S. Cl. CPC H04N 5/66; G02B 6/0013
USPC 348/739; 362/609

(57) ABSTRACT

This display device includes a display device body, a display portion arranged on the front side of the display device body, configured to display an image, a light source supplying light to the display portion, a first light guide plate arranged to be opposed to the light source, having a light incident surface including a side surface on which light emitted from the light source is incident and a light emitting surface provided on a side surface opposite to the light incident surface to emit the light incident from the light incident surface, a second light guide plate arranged to overlap with the first light guide plate, guiding the light emitted from the light emitting surface of the first light guide plate to the display portion, and a first reflective member arranged between the first light guide plate and the second light guide plate.

### BACKGROUND OF THE INVENTION

1. Field of the Invention

The present invention relates to a display device and a television set, and more particularly, it relates to a display device and a television set each including a light source and a light guide plate.

2. Description of the Background Art

A display device including a light source and a light guide plate is known in general, as disclosed in Japanese Patent Laying-Open No. 2003-031016.

Japanese Patent Laying-Open No. 2003-031016 discloses a planar illumination device (display device) including a planar illumination device body (display device body), an object to be illuminated (display portion) arranged on the front side of the planar illumination device body, configured to display an image, and point light sources (light source) supplying light to the object to be illuminated. This planar illumination device includes a linear light guide body having a side surface (light incident surface) on which the point light sources are arranged and on which light emitted from the point light sources is incident and a light emitting surface provided perpendicularly to the side surface, from which the light incident from the side surface is emitted, and a light guide plate arranged to overlap with the linear light guide body, guiding the light emitted from the light emitting surface of the linear light guide body to the object to be illuminated. Furthermore, the linear light guide body has an uneven surface opposite to the light emitting surface so that the traveling direction of the light incident from the side surface is changed to a direction toward the light emitting surface perpendicular to the side surface. The linear light guide body is configured to spread light all over the inside of the linear light guide body and guide the light to the light emitting surface.

Furthermore, in this planar illumination device, the linear light guide body is provided and an optical path to a portion of the light guide plate corresponding to an image display area is lengthened, whereby light is transmitted to the portion of the light guide plate corresponding to the image display area while the light is sufficiently spread. Thus, unevenness in brightness on the object to be illuminated can be suppressed even when the number of the point light sources is reduced. In addition, the linear light guide body is arranged to overlap with the light guide plate, whereby an increase in the outer shape of the light guide plate (an outer portion of the image display area) is suppressed. Consequently, partial darkness (unevenness in brightness) of the light guide plate is suppressed while an increase in the width of a frame of the planar illumination device is suppressed, and the number of the point light sources is reduced.

However, in the planar illumination device according to Japanese Patent Laying-Open No. 2003-031016, the linear light guide body must have the uneven surface opposite to the light emitting surface in order to change the traveling direction of the light incident from the side surface of the linear light guide body to the direction toward the light emitting surface perpendicular to the side surface, and hence the shape of the linear light guide body (light guide plate) is disadvantageously complicated.

### SUMMARY OF THE INVENTION

The present invention has been proposed in order to solve the aforementioned problem, and an object of the present invention is to provide a display device and a television set each capable of suppressing unevenness in brightness on a display portion while suppressing complication of the shape of a light guide plate and an increase in the width of a frame even when the number of light sources is reduced.

A display device according to a first aspect of the present invention includes a display device body, a display portion arranged on the front side of the display device body, configured to display an image, a light source supplying light to the display portion, a first light guide plate arranged to be opposed to the light source, having a light incident surface including a side surface on which light emitted from the light source is incident and a light emitting surface provided on a side surface opposite to the light incident surface to emit the light incident from the light incident surface, a second light guide plate arranged to overlap with the first light guide plate, guiding the light emitted from the light emitting surface of the first light guide plate to the display portion, and a first reflective member arranged between the first light guide plate and the second light guide plate.

As hereinabove described, the display device according to the first aspect of the present invention is provided with the first light guide plate arranged to be opposed to the light source, having the light incident surface including the side surface on which the light emitted from the light source is incident and the light emitting surface formed on the side surface opposite to the light incident surface to emit the light incident from the light incident surface, whereby the light can be emitted from the light emitting surface provided on the side surface opposite to the light incident surface without changing the traveling direction of the light emitted from the light source opposed to the light incident surface. Thus, it is not necessary to form an uneven side surface on the first light guide plate in order to change the traveling direction of the light incident from the light incident surface to a direction perpendicular to the light incident surface, and consequently complication of the shape of the first light guide plate can be suppressed. Furthermore, the first light guide plate is arranged to overlap with the second light guide plate, whereby the light emitted from the light source can be spread inside the first light guide plate and be guided to the second light guide plate while an increase in the outer shape (an outer portion of an image display area) of the second light guide plate in a plan view is suppressed. Consequently, even when the number of light sources is reduced, unevenness in brightness on the display portion can be suppressed while an increase in the width of a frame of the display device is suppressed. Therefore, in this display device, even when the number of light sources is reduced, unevenness in brightness on the display portion can be suppressed while complication of the shape of the first light guide plate is suppressed and an increase in the width of the frame of the display device is suppressed. In addition, the first reflective member is provided between the first light guide plate and the second light guide plate, whereby light leakage from the first light guide plate to the second light guide plate can be suppressed, and hence unevenness in brightness on the display portion can be further suppressed.

In the aforementioned display device according to the first aspect, the first light guide plate preferably has a first light incident surface as the light incident surface, the second light guide plate preferably has a second light incident surface on which the light emitted from the light emitting surface of the first light guide plate is incident, and a reflector reflecting the light emitted from the light emitting surface of the first light guide plate to guide the light to the second light incident surface of the second light guide plate is preferably arranged substantially in front of the light source in the traveling direction of the light emitted from the light source. According to this structure, the light emitted from the light emitting surface of the first light guide plate can be easily guided to the second light incident surface of the second light guide plate by the reflector.

In this case, the reflector preferably has a substantially U-shaped section or a substantially V-shaped section protruding outward and is preferably arranged to cover the light emitting surface and the second light incident surface. According to this structure, the light emitted from the light emitting surface of the first light guide plate can be efficiently guided to the second light incident surface of the second light guide plate by the reflector having the substantially U-shaped section or the substantially V-shaped section.

In the aforementioned display device according to the first aspect, each of the first light guide plate and the second light guide plate preferably has a substantially rectangular shape, the first light guide plate is preferably formed such that the long side thereof extends along the short side of the second light guide plate, and the light source is preferably arranged to be opposed to the long side of the first light guide plate. According to this structure, the light source is opposed to the long side of the first light guide plate, and hence unlike the case where the light source is opposed to the short side of the first light guide plate, the light source can be easily arranged to be opposed to the long side even when a plurality of light sources are arranged, and required luminance can be ensured.

In this case, a plurality of light sources are preferably provided at prescribed intervals in a direction along the long side of the first light guide plate, and the plurality of light sources are preferably arranged to be opposed to the long side of the first light guide plate. According to this structure, the plurality of light sources are opposed to the long side of the first light guide plate at the prescribed intervals, and hence light emitted from the plurality of light sources can be evenly incident on the first light guide plate from the long side, and unevenness in brightness on the display portion can be further suppressed while required luminance is ensured.

In the aforementioned structure in which the plurality of light sources are arranged, the plurality of light sources are preferably arranged at intervals substantially equal to each other, and the plurality of light sources and the first light guide plate are preferably arranged such that light emitting portions of the plurality of light sources are separated from the light incident surface of the first light guide plate by a distance smaller than each of the intervals between the plurality of light sources. According to this structure, the light emitted from the plurality of light sources, efficiently incident on the first light guide plate from the light incident surface of the first light guide plate can be spread inside the first light guide plate and be guided to the second light guide plate, and hence unevenness in brightness on the display portion can be further suppressed.

In the aforementioned display device according to the first aspect, the first light guide plate is preferably configured such that the light incident surface and the light emitting surface thereof are substantially parallel to each other. According to this structure, a distance traveled by the light incident on the first light guide plate and emitted from the first light guide plate can be uniformed regardless of an incident position of the light incident surface of the first light guide plate. Therefore, the light can be spread in a balanced manner inside the first light guide plate and be emitted from the light emitting surface.

In the aforementioned display device according to the first aspect, the first light guide plate preferably has a first light incident surface as the light incident surface, the second light guide plate preferably has a second light incident surface on which the light emitted from the light emitting surface of the first light guide plate is incident, the second light guide plate is preferably configured such that the second light incident surface thereof is substantially flush with the light emitting surface of the first light guide plate, and the light emitted from the light emitting surface provided on a side surface of the first light guide plate opposite to the first light incident surface is preferably incident on the second light incident surface. According to this structure, the light emitted from the light emitting surface of the first light guide plate can be evenly incident on the second light incident surface.

In the aforementioned display device according to the first aspect, the first light guide plate preferably has a thickness substantially equal to the thickness of the second light guide plate. According to this structure, the light emitted from the light emitting surface of the first light guide plate can be efficiently incident on the second light incident surface while an increase in the thickness of the display device is suppressed.

In the aforementioned display device according to the first aspect, the first light guide plate preferably has a thickness larger than the width of the light source in the thickness direction of the first light guide plate. According to this structure, the light emitted from the light source can be efficiently incident on the light incident surface of the first light guide plate.

In the aforementioned display device according to the first aspect, the display portion preferably has an image display area configured to be capable of displaying an image, and the first light guide plate is preferably arranged on the rear side of the second light guide plate such that at least a part of the first light guide plate overlaps the image display area of the display portion. According to this structure, the area of the first light guide plate can be increased while the first light guide plate is arranged to overlap with the second light guide plate. Therefore, the light emitted from the light source can be effectively spread inside the first light guide plate and be guided to the second light guide plate while an increase in the outer shape (the outer portion of the image display area) of the second light guide plate in the plan view is suppressed. Consequently, even when the number of light sources is reduced, unevenness in brightness on the display portion can be further suppressed while an increase in the width of the frame of the display device is suppressed.

In this case, the first light guide plate is preferably arranged such that the first light incident surface thereof overlaps a region near an end of the image display area of the display portion. According to this structure, the display device can provide a compact arrangement, unlike the case where the first light incident surface is arranged in a region overlapping the vicinity of a central portion of the image display area.

In the aforementioned display device according to the first aspect, the first reflective member is preferably arranged not only between the first light guide plate and the second light guide plate but also over a substantially entire region of the second light guide plate on the rear side. According to this structure, the first reflective member is also used as a reflective member for suppressing light leakage from the rear side of the second light guide plate, and hence no reflective member for suppressing light leakage from the rear side of the second light guide plate may be provided separately. Therefore, an increase in the number of components can be suppressed.

The aforementioned display device according to the first aspect preferably further includes a second reflective member arranged on the rear side of the first light guide plate, and the second reflective member is preferably arranged over a substantially entire region of the first light guide plate on the rear side. According to this structure, light leakage rearward from the first light guide plate can be suppressed by the second reflective member, and hence a reduction in the amount of light incident on the second light guide plate resulting from the light leakage rearward from the first light guide plate can be suppressed. Consequently, a reduction in the luminance of the display device (display portion) can be suppressed.

The aforementioned display device according to the first aspect preferably further includes a light source substrate mounted with the light source and further includes a heat sink configured to fix the light source substrate, formed substantially parallel to the first light guide plate, the light source preferably includes a side-view light emitting device emitting light from a side thereof, and the side of the side-view light emitting device is preferably opposed to the light incident surface of the first light guide plate in a state where the light source substrate is fixed to a side, closer to the first light guide plate, of the heat sink. According to this structure, unlike the case where a light source that is a light emitting device emitting light from an upper portion thereof is employed, a surface of the light source substrate mounted with the light source is parallel to the heat sink, and hence an increase in the thickness of the display device in a direction in which the first light guide plate and the second light guide plate overlap with each other can be suppressed.

A television set according to a second aspect of the present invention includes a television set body, a receiving portion receiving a broadcast signal, a display portion arranged on the front side of the television set body, configured to display an image, a light source supplying light to the display portion, a first light guide plate arranged to be opposed to the light source, having a light incident surface including a side surface on which light emitted from the light source is incident and a light emitting surface provided on a side surface opposite to the light incident surface to emit the light incident from the light incident surface, a second light guide plate arranged to overlap with the first light guide plate, guiding the light emitted from the light emitting surface of the first light guide plate to the display portion, and a first reflective member arranged between the first light guide plate and the second light guide plate.

As hereinabove described, the television set according to the second aspect of the present invention is provided with the first light guide plate arranged to be opposed to the light source, having the light incident surface including the side surface on which the light emitted from the light source is incident and the light emitting surface formed on the side surface opposite to the light incident surface to emit the light incident from the light incident surface, whereby the light can be emitted from the light emitting surface provided on the side surface opposite to the light incident surface without changing the traveling direction of the light emitted from the light source opposed to the light incident surface. Thus, it is not necessary to form an uneven side surface on the first light guide plate in order to change the traveling direction of the light incident from the light incident surface to a direction perpendicular to the light incident surface, and consequently complication of the shape of the first light guide plate can be suppressed. Furthermore, the first light guide plate is arranged to overlap with the second light guide plate, whereby the light emitted from the light source can be spread inside the first light guide plate and be guided to the second light guide plate while an increase in the outer shape (an outer portion of an image display area) of the second light guide plate in a plan view is suppressed. Consequently, even when the number of light sources is reduced, unevenness in brightness on the display portion can be suppressed while an increase in the width of a frame of the television set is suppressed. Therefore, in this television set, even when the number of light sources is reduced, unevenness in brightness on the display portion can be suppressed while complication of the shape of the first light guide plate is suppressed and an increase in the width of the frame of the television set is suppressed. In addition, the first reflective member is provided between the first light guide plate and the second light guide plate, whereby light leakage from the first light guide plate to the second light guide plate can be suppressed, and hence unevenness in brightness on the display portion can be further suppressed.

In the aforementioned television set according to the second aspect, the first light guide plate preferably has a first light incident surface as the light incident surface, the second light guide plate preferably has a second light incident surface on which the light emitted from the light emitting surface of the first light guide plate is incident, and a reflector reflecting the light emitted from the light emitting surface of the first light guide plate to guide the light to the second light incident surface of the second light guide plate is preferably arranged substantially in front of the light source in the traveling direction of the light emitted from the light source. According to this structure, the light emitted from the light emitting surface of the first light guide plate can be easily guided to the second light incident surface of the second light guide plate by the reflector.

In this case, the reflector preferably has a substantially U-shaped section or a substantially V-shaped section protruding outward and is preferably arranged to cover the light emitting surface and the second light incident surface. According to this structure, the light emitted from the light emitting surface of the first light guide plate can be efficiently guided to the second light incident surface of the second light guide plate by the reflector having the substantially U-shaped section or the substantially V-shaped section.

In the aforementioned television set according to the second aspect, each of the first light guide plate and the second light guide plate preferably has a substantially rectangular shape, the first light guide plate is preferably formed such that the long side thereof extends along the short side of the second light guide plate, and the light source is preferably arranged to be opposed to the long side of the first light guide plate. According to this structure, the light source is opposed to the long side of the first light guide plate, and hence unlike the case where the light source is opposed to the short side of the first light guide plate, the light source can be easily arranged to be opposed to the long side even when a plurality of light sources are arranged, and required luminance can be ensured.

In this case, a plurality of light sources are preferably provided at prescribed intervals in a direction along the long side of the first light guide plate, and the plurality of light sources are preferably arranged to be opposed to the long side of the first light guide plate. According to this structure, the plurality of light sources are opposed to the long side of the first light guide plate at the prescribed intervals, and hence light emitted from the plurality of light sources can be evenly incident on the first light guide plate from the long side, and unevenness in brightness on the display portion can be further suppressed while required luminance is ensured.

According to the present invention, as hereinabove described, even when the number of light sources is reduced, unevenness in brightness on the display portion can be suppressed while complication of the shape of the light guide plate and an increase in the width of the frame are suppressed.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing the overall structure of a TV according to an embodiment of the present invention;

FIG. 2 is a sectional view taken along the line 500-500 in FIG. 1;

FIG. 3 is a sectional view taken along the line 600-600 in FIG. 2;

FIG. 4 is an enlarged view showing an LED opposed to a first light guide plate of the TV according to the embodiment of the present invention;

FIG. 5 is an enlarged view showing an LED opposed to a first light guide plate of a TV according to a first modification of the embodiment of the present invention;

FIG. 6 is a diagram showing a reflector of a TV according to a second modification of the embodiment of the present invention; and

FIG. 7 is a diagram showing a reflector of a TV according to a third modification of the embodiment of the present invention.

### DESCRIPTION OF THE PREFERRED EMBODIMENTS

An embodiment of the present invention is hereinafter described with reference to the drawings.

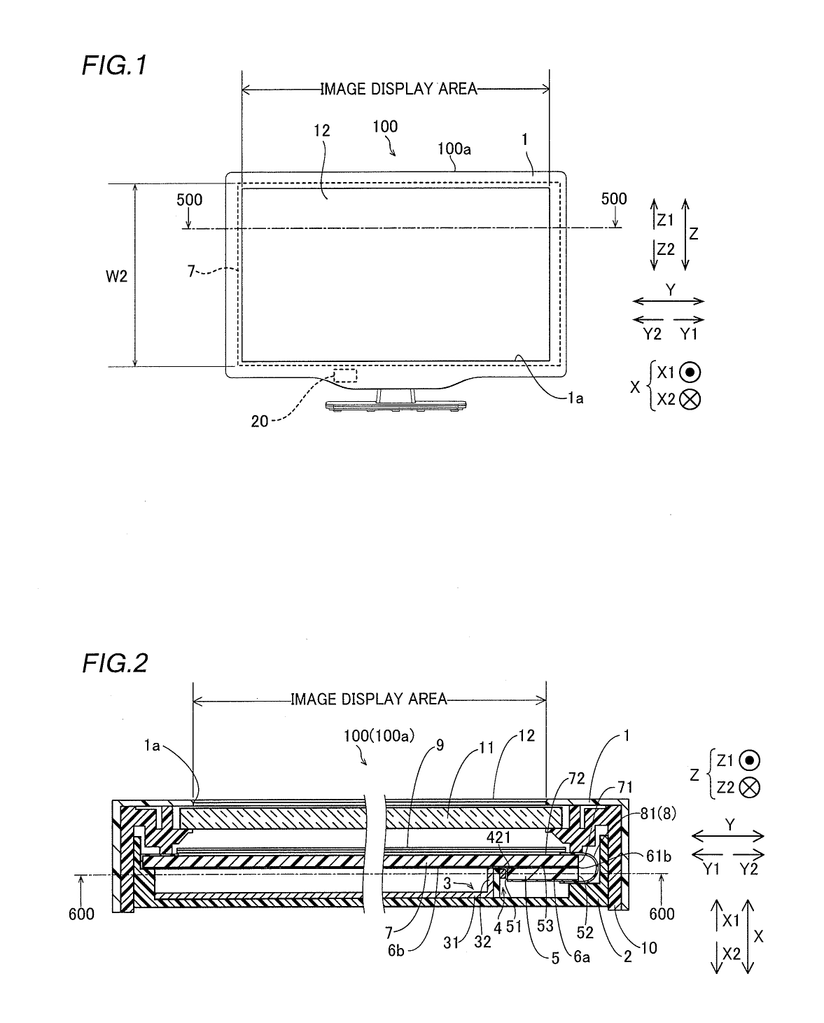

The structure of a TV (television set) 100 according to the embodiment of the present invention is now described with reference to FIGS. 1 to 4. The TV 100 is an example of the “display device” in the present invention.

The TV 100 according to the embodiment of the present invention includes a TV body 100a, a front frame 1 having an opening la, and a rear frame 2 (see FIG. 2), as shown in FIG. 1. An antireflective sheet 12 described later is exposed from the opening 1a of the front frame 1. The TV body 100a is an example of the “display device body” in the present invention.

Inside the TV 100, a heat sink 3 and an LED module 4 including a plurality of LEDs 42 are arranged, as shown in FIG. 2. Furthermore, inside the TV 100, a first light guide plate 5, reflective sheets 6a and 6b, a second light guide plate 7, a reflector 8, an optical sheet 9, and a resin frame 10 are arranged. On the front side (X1 side) of the resin frame 10, a display portion 11 and the antireflective sheet 12 are arranged. The display portion 11 is mainly constituted by a liquid crystal cell. The display portion 11 is arranged on the front side of the TV body 100a and has an image display area configured to display an image on a region formed of the opening 1a of the front frame 1. The TV 100 is configured to be capable of receiving a broadcast signal through a receiving portion 20 (see FIG. 1). The LEDs 42 are examples of the “light source” in the present invention.

The heat sink 3 has a function of releasing the heat of the LEDs 42. The heat sink 3 is made of metal (sheet metal). The heat sink 3 includes a heat sink body portion 31 and an LED substrate fixing portion 32, as shown in FIGS. 2 and 4. As shown in FIG. 2, on the rear side (X2 side) of the heat sink 3 (heat sink body portion 31), the rear frame 2 is arranged. As shown in FIGS. 2 and 4, the heat sink body portion 31 is flattened to extend in a direction Y. The LED substrate fixing portion 32 is formed by substantially vertically bending a portion of the heat sink 3 on the Y2 side frontward (along arrow X1).

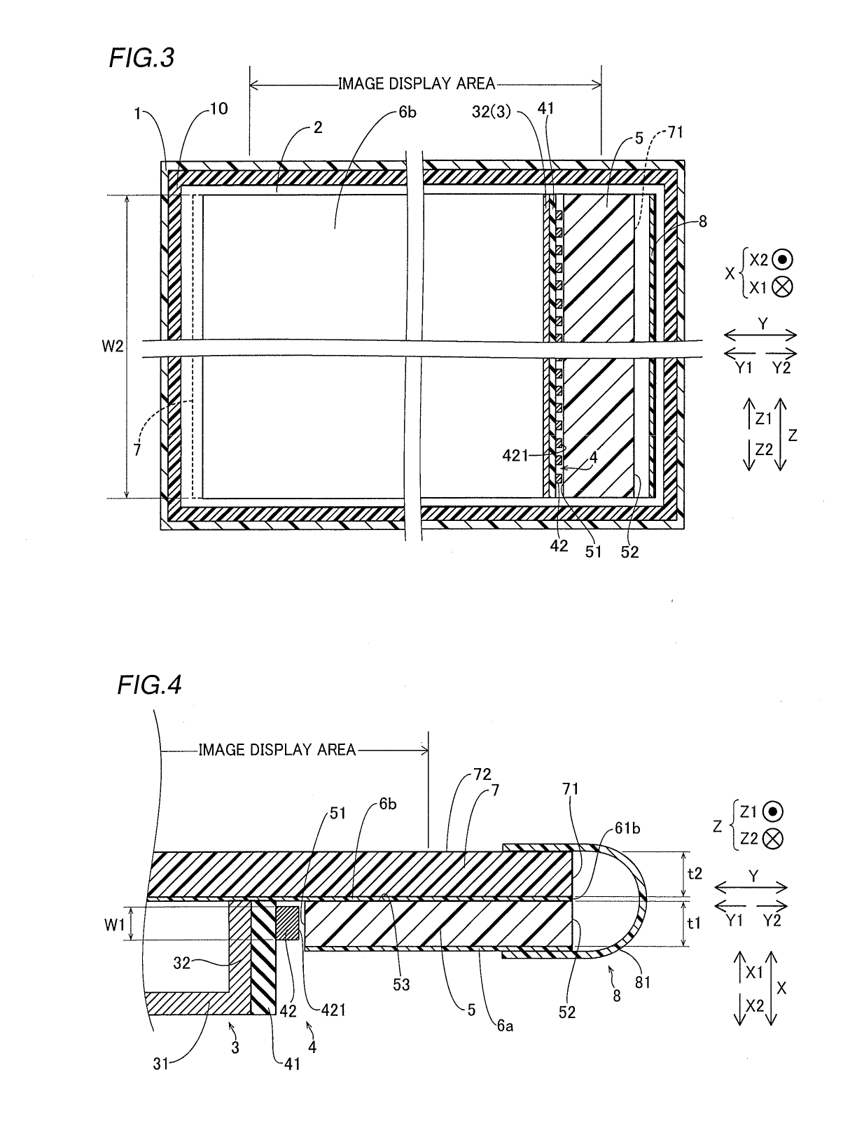

According to this embodiment, the LED module 4 includes an LED substrate 41 and the plurality of LEDs 42 mounted on the LED substrate 41, as shown in FIG. 3. The LED substrate 41 is attached and fixed to the LED substrate fixing portion 32 by an unshown double-faced adhesive tape. The plurality of LEDs 42 are provided at prescribed intervals (substantially equal intervals) in a direction (direction Z) along a first light incident surface 51 (the long side of the first light guide plate 5) of the first light guide plate 5 described later. The LEDs 42 are configured to supply light to the display portion 11. The LEDs 42 are top-view LEDs having light emitting portions 421 (the upper portions of the devices) emitting light. The LED module 4 is arranged on the left side (Y2 side) when the TV body 100a (see FIG. 1) is viewed from the front side, as shown in FIGS. 2 to 4. The plurality of LEDs 42 and the first light guide plate 5 are arranged such that the light emitting portions 421 of the plurality of LEDs 42 are separated from the first light incident surface 51 of the first light guide plate 5 by a distance smaller than each of the intervals between the plurality of LEDs 42.

According to this embodiment, the first light guide plate 5 has a function of guiding light to the display portion 11. As shown in FIG. 3, the first light guide plate 5 has a substantially rectangular shape. The first light guide plate 5 is arranged to be opposed to the LEDs 42 and has the first light incident surface 51 including a side surface on which light emitted from the LEDs 42 is incident and a first light emitting surface 52 provided on a side surface (on the Y2 side) opposite to the first light incident surface 51, from which the light incident from the first light incident surface 51 is emitted, as shown in FIGS. 2 to 4. The first light incident surface 51 (the long side on the Y1 side) is arranged to be opposed to the plurality of LEDs 42, as shown in FIG. 3. Furthermore, the first light incident surface 51 is provided on the Y1 side of the first light guide plate 5, as shown in FIGS. 2 to 4. In addition, the first light incident surface 51 is substantially parallel to the first light emitting surface 52. In other words, the first light guide plate 5 has the first light incident surface 51 and the first light emitting surface 52 substantially parallel to each other. The first light guide plate 5 is arranged such that a part of the first light guide plate 5 on the Y1 side overlaps the image display area of the display portion 11. The first light guide plate 5 is arranged such that the first light incident surface 51 overlaps a region near an end of the image display area of the display portion 11. The first light incident surface 51 is arranged substantially in front of the light emitting portions 421 of the LEDs 42. As shown in FIG. 4, the first light incident surface 51 has a thickness t1 larger than the width W1 of each of the LEDs 42 in a direction X. In other words, the first light guide plate 5 has the thickness t1 larger than the width W1 of each of the LEDs 42 in the thickness direction (direction X) of the first light guide plate 5. The first light incident surface 51 is an example of the “light incident surface” in the present invention, and the first light emitting surface 52 is an example of the “light emitting surface” in the present invention.

According to this embodiment, the reflective sheet 6a suppressing light leakage is arranged on the rear side (X2 side) of the first light guide plate 5, as shown in FIGS. 2 and 4. Furthermore, the reflective sheet 6a is arranged over a substantially entire region of the first light guide plate 5 on the rear side. In other words, the reflective sheet 6a is formed in a shape corresponding to the shape of the first light guide plate 5, as viewed from the X2 side. The reflective sheet 6a is an example of the “second reflective member” in the present invention.

According to this embodiment, the reflective sheet 6b suppressing light leakage is arranged between the first light guide plate 5 and the second light guide plate 7, as shown in FIGS. 2 and 4. The reflective sheet 6b is formed to cover the entire front surface 53 of the first light guide plate 5. The reflective sheet 6b is arranged not only between the first light guide plate 5 and the second light guide plate 7 but also over a substantially entire region of the second light guide plate 7 on the rear side (X2 side). In other words, the reflective sheet 6b is formed in a shape corresponding to the shape of the second light guide plate 7, as viewed in the direction X. The reflective sheets 6a and 6b are made of the same material (polyester, for example). The reflective sheet 6b is an example of the “first reflective member” in the present invention.

According to this embodiment, the second light guide plate 7 is arranged to overlap with the first light guide plate 5, as shown in FIGS. 2 and 4, and is configured to guide the light emitted from the first light emitting surface 52 of the first light guide plate 5 to the display portion 11 (see FIG. 2). Specifically, the second light guide plate 7 is arranged on the front side (X1 side) of the first light guide plate 5 on the Y2 side of the TV body 100a. The second light guide plate 7 has a substantially rectangular shape (see FIG. 1). On the Y2 side, the second light guide plate 7 has a second light incident surface 71 on which the light emitted from the first light emitting surface 52 of the first light guide plate 5 is incident. The second light guide plate 7 also has a second light emitting surface 72 emitting the light to the display portion 11 on the front side. The first light incident surface 51 (the long side on the Y1 side) and the first light emitting surface 52 (the long side on the Y2 side) of the first light guide plate 5 are formed to extend along the second light incident surface 71 (short side) of the second light guide plate 7. The first light guide plate 5 is arranged on the rear side (X2 side) of the second light guide plate 7. The second light incident surface 71 of the second light guide plate 7 has a width W2 equal to the widths of the first light incident surface 51 and the first light emitting surface 52 of the first light guide plate 5, as shown in FIG. 3. The second light guide plate 7 has an area larger than that of the first light guide plate 5. The second light incident surface 71 of the second light guide plate 7 is flush with the first light emitting surface 52 of the first light guide plate 5 and an end surface 61b of the reflective sheet 6b, as shown in FIGS. 2 and 4. The second light guide plate 7 has a thickness t2 equal to the thickness t1 of the first light guide plate 5, as shown in FIG. 4. The first light guide plate 5 and the second light guide plate 7 are made of the same material (acrylic resin, for example).

The reflector 8 has a function of reflecting the light emitted from the first light emitting surface 52 of the first light guide plate 5 to guide the light to the second light incident surface 71 of the second light guide plate 7, as shown in FIGS. 2 and 4. The reflector 8 is arranged substantially in front of the LEDs 42 in the traveling direction (along arrow Y2) of the light emitted from the LEDs 42. The reflector 8 has a reflecting portion 81 reflecting light, having a substantially U-shaped section protruding outward (along arrow Y2). Furthermore, the reflector 8 is formed to protrude in the traveling direction (along arrow Y2) of the light inside the first light guide plate 5. The reflector 8 is made of the same material as the reflective sheets 6a and 6b. The reflector 8 is arranged to cover the first light emitting surface 52 of the first light guide plate 5 and the second light incident surface 71 of the second light guide plate 7 along the direction Z. The reflector 8 is configured to hold the first light guide plate 5, the reflective sheets 6a and 6b, and the second light guide plate 7 from the outside in the anteroposterior direction (direction X) of the TV 100.

As shown in FIG. 2, on the front side (X1 side) of the second light guide plate 7, the optical sheet 9 efficiently transmitting the light emitted from the second light emitting surface 72 of the second light guide plate 7 to the display portion 11 is provided.

The resin frame 10 has a function of fixing the first light guide plate 5 and the second light guide plate 7 to the TV body 100a, as shown in FIG. 2. Specifically, the first light guide plate 5 and the second light guide plate 7 are fixed to the TV body 100a in a state of being held between the resin frame 10 and the rear frame 2.

The display portion 11 is arranged on the front side (X1 side) of the resin frame 10, as shown in FIG. 2. The antireflective sheet 12 preventing reflection is arranged on the front side of the display portion 11.

According to this embodiment, as hereinabove described, the TV 100 is provided with the first light guide plate 5 arranged to be opposed to the LEDs 42, having the first light incident surface 51 on which the light emitted from the LEDs 42 is incident and the first light emitting surface 52 formed opposite to the first light incident surface 51 to emit the incident light, whereby the light can be emitted from the first light emitting surface 52 provided opposite to the first light incident surface 51 without changing the traveling direction of the light emitted from the LEDs 42 opposed to the first light incident surface 51. Thus, it is not necessary to form an uneven side surface on the first light guide plate 5 in order to change the traveling direction of the light incident from the first light incident surface 51 to a direction perpendicular to the first light incident surface 51, and consequently complication of the shape of the first light guide plate 5 can be suppressed. Furthermore, the first light guide plate 5 is arranged to overlap with the second light guide plate 7, whereby the light emitted from the LEDs 42 can be spread inside the first light guide plate 5 and be guided to the second light guide plate 7 while an increase in the outer shape (an outer portion of the image display area) of the second light guide plate 7 in a plan view is suppressed. Consequently, even when the number of the LEDs 42 is reduced, unevenness in brightness on the display portion 11 can be suppressed while an increase in the width of the frame of the TV 100 is suppressed. Therefore, in this TV 100, even when the number of the LEDs 42 is reduced, unevenness in brightness on the display portion 11 can be suppressed while complication of the shape of the first light guide plate 5 is suppressed and an increase in the width of the frame of the TV 100 is suppressed. In addition, the reflective sheet 6b is provided between the first light guide plate 5 and the second light guide plate 7, whereby light leakage from the first light guide plate 5 to the second light guide plate 7 can be suppressed, and hence unevenness in brightness on the display portion 11 can be further suppressed.

According to this embodiment, as hereinabove described, the reflector 8 reflecting the light emitted from the first light emitting surface 52 of the first light guide plate 5 to guide the light to the second light incident surface 71 of the second light guide plate 7 is provided substantially in front of the LEDs 42 in the traveling direction of the light emitted from the LEDs 42. Thus, the light emitted from the first light emitting surface 52 of the first light guide plate 5 can be easily guided to the second light incident surface 71 of the second light guide plate 7 by the reflector 8.

According to this embodiment, as hereinabove described, the reflector 8 has the substantially U-shaped section protruding outward and is arranged to cover the first light emitting surface 52 of the first light guide plate 5 and the second light incident surface 71 of the second light guide plate 7. Thus, the light emitted from the first light emitting surface 52 of the first light guide plate 5 can be efficiently guided to the second light incident surface 71 of the second light guide plate 7 by the reflector 8 having the substantially U-shaped section.

According to this embodiment, as hereinabove described, the TV 100 is provided with the first light guide plate 5 and the second light guide plate 7 each having the substantially rectangular shape, the first light guide plate 5 is formed such that the long side thereof extends along the short side of the second light guide plate 7, and the LEDs 42 are arranged to be opposed to the long side of the first light guide plate 5. Thus, the LEDs 42 are opposed to the long side of the first light guide plate 5, and hence unlike the case where the LEDs 42 are opposed to the short side of the first light guide plate 5, the LEDs 42 can be easily arranged to be opposed to the long side even when the plurality of LEDs 42 are arranged, and required luminance can be ensured.

According to this embodiment, as hereinabove described, the first light guide plate 5 and the second light guide plate 7 each have the substantially rectangular shape and are formed such that the first light emitting surface 52 (long side) of the first light guide plate 5 extends along the second light incident surface 71 (short side) of the second light guide plate 7, and the LEDs 42 are arranged to be opposed to the first light incident surface 51 of the first light guide plate 5. Thus, the plurality of LEDs 42 can be easily arranged to be opposed to the first light incident surface 51 (long side) of the first light guide plate 5, and required luminance can be ensured.

According to this embodiment, as hereinabove described, the plurality of LEDs 42 are provided at the prescribed intervals in a direction along the first light incident surface 51 (long side) of the first light guide plate 5, and the plurality of LEDs 42 are arranged to be opposed to the first light incident surface 51 (long side) of the first light guide plate 5. Thus, the plurality of LEDs 42 are opposed to the first light incident surface 51 (long side) of the first light guide plate 5 at the prescribed intervals, and hence the light emitted from the plurality of LEDs 42 can be evenly incident on the first light guide plate 5 from the first light incident surface 51 (long side), and unevenness in brightness on the display portion 11 can be further suppressed while required luminance is ensured.

According to this embodiment, as hereinabove described, the plurality of LEDs 42 are arranged at the intervals substantially equal to each other, and the plurality of LEDs 42 and the first light guide plate 5 are arranged such that the light emitting portions 421 of the plurality of LEDs 42 are separated from the first light incident surface 51 of the first light guide plate 5 by the distance smaller than each of the intervals between the plurality of LEDs 42. Thus, the light emitted from the plurality of LEDs 42, efficiently incident on the first light guide plate 5 from the first light incident surface 51 of the first light guide plate 5 can be spread inside the first light guide plate 5 and be guided to the second light guide plate 7, and hence unevenness in brightness on the display portion 11 can be further suppressed.

According to this embodiment, as hereinabove described, the first light guide plate 5 is configured such that the first light incident surface 51 and the first light emitting surface 52 thereof are substantially parallel to each other. Thus, a distance traveled by the light incident on the first light guide plate 5 and emitted from the first light guide plate 5 can be uniformed regardless of an incident position of the first light incident surface 51 of the first light guide plate 5. Therefore, the light can be spread in a balanced manner inside the first light guide plate 5 and be emitted from the first light emitting surface 52.

According to this embodiment, as hereinabove described, the second light guide plate 7 is configured such that the second light incident surface 71 thereof is substantially flush with the first light emitting surface 52 of the first light guide plate 5, and the light emitted from the first light emitting surface 52 provided on the side surface of the first light guide plate 5 opposite to the first light incident surface 51 is incident on the second light incident surface 71. Thus, the light emitted from the first light emitting surface 52 of the first light guide plate 5 can be evenly incident on the second light incident surface 71.

According to this embodiment, as hereinabove described, the first light guide plate 5 has the thickness substantially equal to the thickness of the second light guide plate 7. Thus, the light emitted from the first light emitting surface 52 of the first light guide plate 5 can be efficiently incident on the second light incident surface 71 while an increase in the thickness of the TV 100 is suppressed.

According to this embodiment, as hereinabove described, the first light guide plate 5 has the thickness larger than the width of each of the LEDs 42 in the thickness direction of the first light guide plate 5. Thus, the light emitted from the LEDs 42 can be efficiently incident on the first light incident surface 51 of the first light guide plate 5.

According to this embodiment, as hereinabove described, the first light guide plate 5 is arranged on the rear side of the second light guide plate 7 such that a part thereof overlaps the image display area of the display portion 11. Thus, the area of the first light guide plate 5 can be increased while the first light guide plate 5 is arranged to overlap with the second light guide plate 7. Therefore, the light emitted from the LEDs 42 can be effectively spread inside the first light guide plate 5 and be guided to the second light guide plate 7 while an increase in the outer shape (the outer portion of the image display area) of the second light guide plate 7 in the plan view is suppressed. Consequently, even when the number of the LEDs 42 is reduced, unevenness in brightness on the display portion 11 can be further suppressed while an increase in the width of the frame of the TV 100 is suppressed.

According to this embodiment, as hereinabove described, the first light guide plate 5 is arranged such that the first light incident surface 51 thereof overlaps the region near the end of the image display area of the display portion 11. Thus, the TV 100 can provide a compact arrangement, unlike the case where the first light incident surface 51 is arranged in a region overlapping the vicinity of a central portion of the image display area.

According to this embodiment, as hereinabove described, the reflective sheet 6b is arranged not only between the first light guide plate 5 and the second light guide plate 7 but also over the substantially entire region of the second light guide plate 7 on the rear side. Thus, the reflective sheet 6b is also used as a reflective member for suppressing light leakage from the rear side of the second light guide plate 7, and hence no reflective member for suppressing light leakage from the rear side of the second light guide plate 7 may be provided separately. Therefore, an increase in the number of components can be suppressed.

According to this embodiment, as hereinabove described, the reflective sheet 6a is arranged over the substantially entire region of the first light guide plate 5 on the rear side. Thus, light leakage rearward from the first light guide plate 5 can be suppressed by the reflective sheet 6a, and hence a reduction in the amount of light incident on the second light guide plate 7 resulting from the light leakage rearward from the first light guide plate 5 can be suppressed. Consequently, a reduction in the luminance of the TV 100 (display portion 11) can be suppressed.

The embodiment disclosed this time must be considered as illustrative in all points and not restrictive. The range of the present invention is shown not by the above description of the embodiment but by the scope of claims for patent, and all modifications within the meaning and range equivalent to the scope of claims for patent are further included.

For example, while the present invention is applied to the TV (television set) as the display device in the aforementioned embodiment, the present invention is not restricted to this. The present invention is also applicable to another display device such as a monitor of a PC (personal computer).

While the first light incident surface (light incident surface) and the first light emitting surface (light emitting surface) of the first light guide plate are parallel to each other in the aforementioned embodiment, the present invention is not restricted to this. According to the present invention, the light incident surface and the light emitting surface of the first light guide plate may not be parallel to each other.

While the first light guide plate and the LEDs (light source) arranged to be opposed to the first light guide plate are provided on the Y2 side of the TV body (display device body) in the aforementioned embodiment, the present invention is not restricted to this. According to the present invention, the first light guide plate and the light source arranged to be opposed to the first light guide plate may alternatively be provided on the Y1 side of the display device body. Alternatively, the first light guide plate and the light source arranged to be opposed to the first light guide plate may be provided on both the Y1 side and the Y2 side of the display device body.

While the first light emitting surface (light emitting surface) of the first light guide plate and the second light incident surface of the second light guide plate are flush with each other in the aforementioned embodiment, the present invention is not restricted to this. According to the present invention, the light emitting surface of the first light guide plate and the second light incident surface of the second light guide plate may not be flush with each other. Alternatively, the light emitting surface of the first light guide plate and the second light incident surface of the second light guide plate may not be parallel to each other.

While the first light guide plate overlaps in part the image display area in the aforementioned embodiment, the present invention is not restricted to this. According to the present invention, the first light guide plate may alternatively overlap in whole the image display area. Alternatively, the first light guide plate may not overlap the image display area.

While the first light guide plate and the second light guide plate have the thicknesses substantially equal to each other in the aforementioned embodiment, the present invention is not restricted to this. According to the present invention, the first light guide plate and the second light guide plate may alternatively have thicknesses different from each other.

While the top-view LEDs (light source) emitting light from the upper portions of the devices are provided on the L-shaped heat sink in the aforementioned embodiment, the present invention is not restricted to this. According to the present invention, a side-view light source 142 emitting light from a side 142a of the device may alternatively be provided on a heat sink formed substantially parallel to a first light guide plate, as in a first modification shown in FIG. 5. Specifically, the side 142a of the light emitting device is opposed to a light incident surface of the first light guide plate in a state where a light source substrate 104 is fixed to the side (X1 side), closer to the first light guide plate, of the heat sink formed substantially parallel to the first light guide plate.

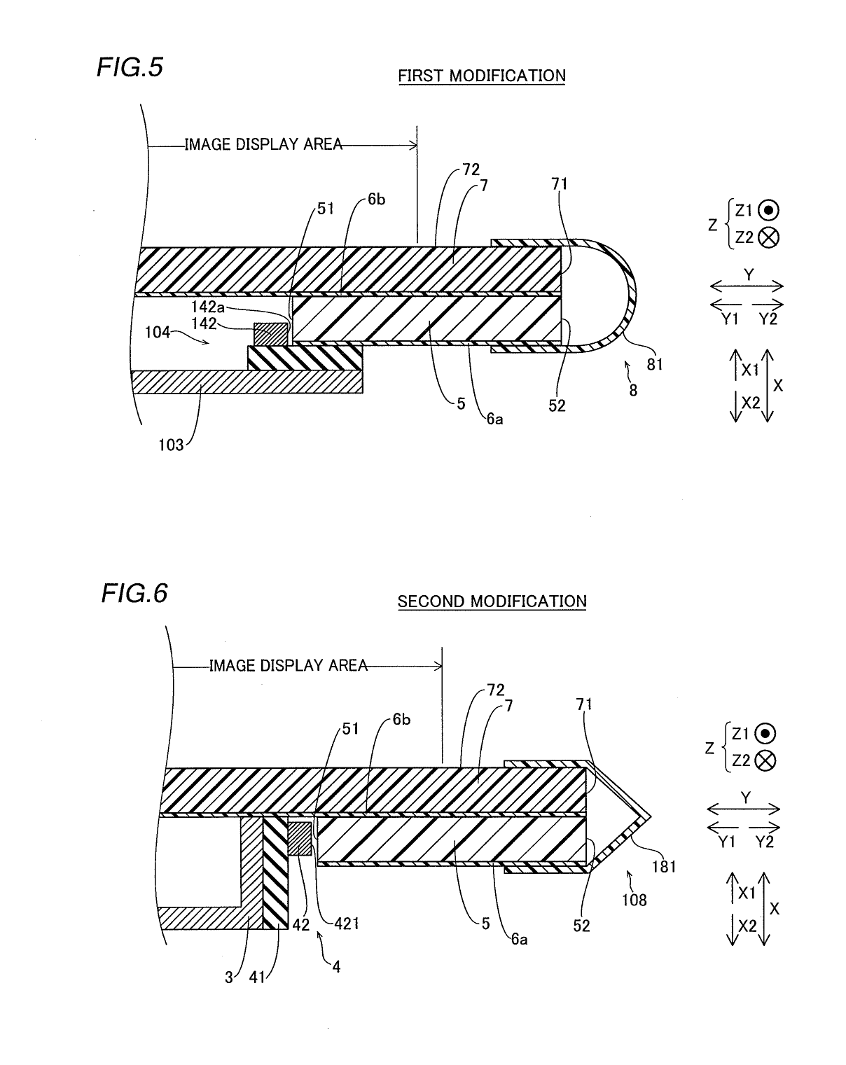

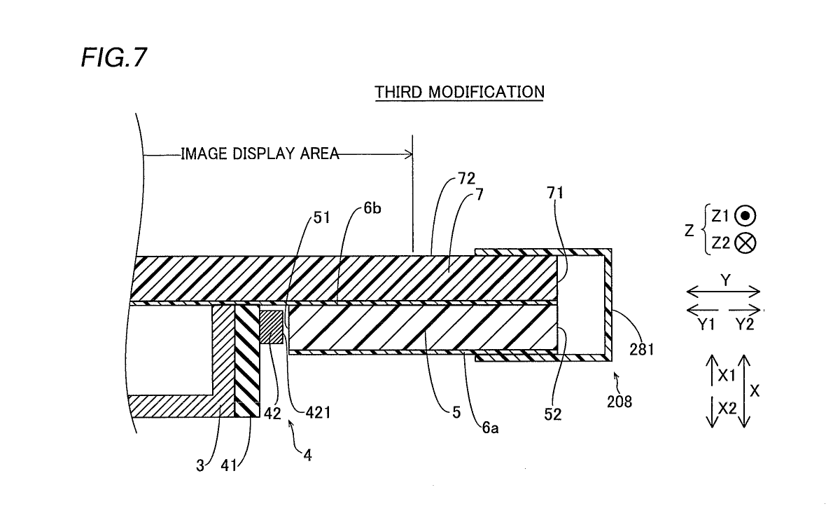

While the reflector having the reflecting portion with the substantially U-shaped section is provided in the aforementioned embodiment, the present invention is not restricted to this. According to the present invention, a reflector 108 having a reflecting portion 181 with a triangular (substantially V-shaped) section may alternatively be provided, as in a second modification shown in FIG. 6. Alternatively, a reflector 208 having a reflecting portion 281 with a concave section may be provided, as in a third modification shown in FIG. 7.

What is claimed is:

1. A display device comprising:
a display device body;
a display portion arranged on a front side of the display device body, configured to display an image;
a light source supplying light to the display portion;
a first light guide plate arranged to be opposed to the light source, having a light incident surface including a side surface on which light emitted from the light source is incident and a light emitting surface provided on a side surface opposite to the light incident surface to emit the light incident from the light incident surface;
a second light guide plate arranged to overlap with the first light guide plate, guiding the light emitted from the light emitting surface of the first light guide plate to the display portion; and
a first reflective member arranged between the first light guide plate and the second light guide plate.

2. The display device according to claim 1, wherein
the first light guide plate has a first light incident surface as the light incident surface,
the second light guide plate has a second light incident surface on which the light emitted from the light emitting surface of the first light guide plate is incident, and
a reflector reflecting the light emitted from the light emitting surface of the first light guide plate to guide the light to the second light incident surface of the second light guide plate is arranged substantially in front of the light source in a traveling direction of the light emitted from the light source.

3. The display device according to claim 2, wherein
the reflector has a substantially U-shaped section or a substantially V-shaped section protruding outward and is arranged to cover the light emitting surface and the second light incident surface.

4. The display device according to claim 1, wherein
each of the first light guide plate and the second light guide plate has a substantially rectangular shape,
the first light guide plate is formed such that a long side thereof extends along a short side of the second light guide plate, and
the light source is arranged to be opposed to the long side of the first light guide plate.

5. The display device according to claim 4, wherein
a plurality of light sources are provided at prescribed intervals in a direction along the long side of the first light guide plate, and
the plurality of light sources are arranged to be opposed to the long side of the first light guide plate.

6. The display device according to claim 5, wherein
the plurality of light sources are arranged at intervals substantially equal to each other, and
the plurality of light sources and the first light guide plate are arranged such that light emitting portions of the plurality of light sources are separated from the light incident surface of the first light guide plate by a distance smaller than each of the intervals between the plurality of light sources.

7. The display device according to claim 1, wherein
the first light guide plate is configured such that the light incident surface and the light emitting surface thereof are substantially parallel to each other.

8. The display device according to claim 1, wherein
the first light guide plate has a first light incident surface as the light incident surface,
the second light guide plate has a second light incident surface on which the light emitted from the light emitting surface of the first light guide plate is incident,
the second light guide plate is configured such that the second light incident surface thereof is substantially flush with the light emitting surface of the first light guide plate, and
the light emitted from the light emitting surface provided on a side surface of the first light guide plate opposite to the first light incident surface is incident on the second light incident surface.

9. The display device according to claim 1, wherein
the first light guide plate has a thickness substantially equal to a thickness of the second light guide plate.

10. The display device according to claim 1, wherein
the first light guide plate has a thickness larger than a width of the light source in a thickness direction of the first light guide plate.

11. The display device according to claim 1, wherein
the display portion has an image display area configured to be capable of displaying an image, and
the first light guide plate is arranged on a rear side of the second light guide plate such that at least a part of the first light guide plate overlaps the image display area of the display portion.

12. The display device according to claim 11, wherein
the first light guide plate is arranged such that the first light incident surface thereof overlaps a region near an end of the image display area of the display portion.

13. The display device according to claim 1, wherein
the first reflective member is arranged not only between the first light guide plate and the second light guide plate but also over a substantially entire region of the second light guide plate on a rear side.

14. The display device according to claim 1, further comprising a second reflective member arranged on a rear side of the first light guide plate, wherein
the second reflective member is arranged over a substantially entire region of the first light guide plate on the rear side.

15. The display device according to claim 1, further comprising a light source substrate mounted with the light source,
further comprising a heat sink configured to fix the light source substrate, formed substantially parallel to the first light guide plate, wherein
the light source comprises a side-view light emitting device emitting light from a side thereof, and
the side of the side-view light emitting device is opposed to the light incident surface of the first light guide plate in a state where the light source substrate is fixed to a side, closer to the first light guide plate, of the heat sink.

16. A television set comprising:
a television set body;
a receiving portion receiving a broadcast signal;
a display portion arranged on a front side of the television set body, configured to display an image;
a light source supplying light to the display portion;
a first light guide plate arranged to be opposed to the light source, having a light incident surface including a side surface on which light emitted from the light source is incident and a light emitting surface provided on a side surface opposite to the light incident surface to emit the light incident from the light incident surface;
a second light guide plate arranged to overlap with the first light guide plate, guiding the light emitted from the light emitting surface of the first light guide plate to the display portion; and
a first reflective member arranged between the first light guide plate and the second light guide plate.

17. The television set according to claim 16, wherein
the first light guide plate has a first light incident surface as the light incident surface,
the second light guide plate has a second light incident surface on which the light emitted from the light emitting surface of the first light guide plate is incident, and
a reflector reflecting the light emitted from the light emitting surface of the first light guide plate to guide the light to the second light incident surface of the second light guide plate is arranged substantially in front of the light source in a traveling direction of the light emitted from the light source.

18. The television set according to claim 17, wherein
the reflector has a substantially U-shaped section or a substantially V-shaped section protruding outward and is arranged to cover the light emitting surface and the second light incident surface.

19. The television set according to claim 16, wherein
each of the first light guide plate and the second light guide plate has a substantially rectangular shape,
the first light guide plate is formed such that a long side thereof extends along a short side of the second light guide plate, and
the light source is arranged to be opposed to the long side of the first light guide plate.

20. The television set according to claim 19, wherein
a plurality of light sources are provided at prescribed intervals in a direction along the long side of the first light guide plate, and
the plurality of light sources are arranged to be opposed to the long side of the first light guide plate.
